(19) United States
(12) Patent Application Publication
(10) Pub. No.: US 2020/0186371 A1
(43) Pub. Date: Jun. 11, 2020

(54) APPARATUS AND METHOD

(71) Applicant: WingArc 1st Inc., Tokyo (JP)

(72) Inventors: Tomohiro Shioya, Tokyo (JP); Shuichi Fujiwara, Tokyo (JP); Yasuhiro Kawase, Tokyo (JP)

(21) Appl. No.: 16/705,822

(22) Filed: Dec. 6, 2019

(30) Foreign Application Priority Data
Dec. 7, 2018 (JP) 2018-230040

(51) Int. Cl. H04L 12/18; H04L 12/58; G06Q 10/06

(52) U.S. Cl. CPC H04L 12/1822; H04L 51/04; G06Q 10/107; G06Q 10/06311; H04L 12/1818

(57) ABSTRACT

A task management unit 21 that manages contents assigned to a task executed by users, a state transition of the task, and the like, a chat management unit 22 that manages message exchange in a chat room associated with the task, contents assigned to the chat, and the like, an information processing unit 23 that performs a predetermined information processing by using task management information and chat management information, and an information presentation unit 24 that presents a result of the information processing to the user are included, and a result of the information processing indicating an execution state of the task and the chat can be presented to the user when execution of the task is completed in cooperation with the chat, thereby providing useful information for improving the task execution to the user.

### BACKGROUND OF THE INVENTION

### Technical Field

The present invention relates to a cooperation management device and a cooperation management method, and in particular, is suitable for use in a device and a method for managing a task performed by users and a chat that is a communication means between the users relating to the task in cooperation with each other.

### Background Art

In recent years, business chat has begun to be used for various business tasks. A main purpose of the business chat is to facilitate internal communication by using the chat instead of e-mail, and a business chat is also provided which includes functions such as business task management, schedule management, efficient information sharing, workflow management, and automatic document creation, as well as business communication through the chat.

For example, with regard to the task management, a technique relating to generating a task from conversation information is known (for example, see Patent Documents 1 and 2). In addition, a technique relating to managing the conversation information and the task in association with each other is also known (for example, see Patent Documents 3 to 5).

In a system described in Patent Document 1, a server that provides a task providing platform based on a deep learning artificial neural network extracts conversation information from at least one message application installed in an electronic device, and extracts task information from the conversation information by using a convolutional neural network (CNN) learning module for natural language processing and a recurrent neural network (RNN) learning model for sentence generation. Then, the extracted task information is provided to a task providing application installed in the electronic device.

In a system described in Patent Document 2, text contents searched from a chat session based on the Internet are extracted, parsed, and a clue word or a term included in the parsed text is used, and then it is determined whether text contents or a part of the text contents can be classified as a task. Then, the identified task is presented to the user and, when accepted, the task is taken into the user's task application.

A system described in Patent Document 3 includes a mechanism that links a task and writing on a bulletin board generated from the task, and organizes and shares the writing for each task. For example, an employee registers work contents in a project, and registers a progress as needed. When a problem occurs in the work, the problem is written on the bulletin board, and the employee who belongs to the project is asked to provide an advice. When it is considered that the employee who belongs to the project cannot solve the problem, an advice is asked for throughout the company by writing the problem in a daily record. Then, a sales member of the product who has read the daily record writes an advice.

A system described in Patent Document 4 includes a memory unit including a business activity map memory area relating to a business activity map including business activities of members and a chat room memory area relating to a chat room embodied through a message thread, and a business activity map processing unit that, when the business activity is received from a first member, determines whether to create a chat room for communication in the business activity map for the business activity and updates the business activity map in association with the message thread. The chat room relates to the business activity map and is implemented through the message thread. Specifically, the chat room is generated in association with a specific business activity at the request of the user.

In a system described in Patent Document 5, a message communication tool recognizes, as a task, a message including project information relating to a project and completion date information of the project or a task relating to the project, tracks the task, identifies members and non-members for the task by tracking the task, assigns the task associated with the project through the message communication tool to the non-members, and grants the non-members a right to use the task, such that the non-members and the members can cooperate.

Patent Document 1: JP-A-2018-41443

Patent Document 2: JP-T-2014-523585

Patent Document 3: JP-A-2009-187044

Patent Document 4: JP-A-2018-113012

Patent Document 5: JP-A-2017-201529

### SUMMARY OF THE INVENTION

As described above, various systems that use the chat in the business activities are provided. However, all the systems in the related art only provided the mechanism relating to generation of the task and management of the task being executed, and none of them provided a mechanism for effectively utilizing completed tasks. Therefore, there was a problem that, for example, after the task is executed by a team using a business chat system, it was not possible to know what to look for even when trying to connect to an improvement in the next execution in terms of how to execute the task, how to communicate via the chat, or the like, and thus it was not possible to make an effective improvement.

The present invention has been made to solve such a problem, and an object thereof is to provide useful information for enabling a user to make an effective improvement based on a situation during execution of a task using a chat after completing execution of the task.

In order to solve the above-described problem, in the present invention, generation of a task that is executed by a user, a person in charge of executing the task, contents assigned to the task, and a state transition from a start to a completion of the task are managed and generation of a chat room for executing a chat in association with the task, participants in the chat room, message exchange in the chat room, and contents assigned to the chat are managed. Then, when the task is completed, and the like, a predetermined information processing is performed using one or more pieces of management information relating to the task and one or more pieces of management information relating to the chat, and a result of the information processing is presented to the user.

According to the present invention configured as described above, when execution of the task is completed in association with the chat, the predetermined information processing is executed by using one or more pieces of management information relating to the task managed during execution of the task and one or more pieces of management information relating to the chat, and the result of the information processing is presented to the user. The result of this information processing is useful information indicating an execution state of the task and the chat, and the user can make an effective improvement based on the state during execution of the task, using the presented information.

### BRIEF DESCRIPTION OF THE DRAWINGS

FIG. 1 is a diagram illustrating an example of an overall configuration of a chat/task management system to which a cooperation management device according to the present embodiment is applied.

FIG. 2 is a block diagram illustrating an example of a functional configuration of a server device (cooperation management device) according to the present embodiment.

FIG. 3 is a diagram illustrating an example of task data (task management information) stored in a task data storage unit of the present embodiment.

FIG. 4 is a diagram illustrating an example of chat room data (chat management information) stored in a chat room data storage unit of the present embodiment.

FIG. 5 is a diagram illustrating an example of message data (chat management information) stored in a message data storage unit of the present embodiment.

FIGS. 6A and 6B diagrams illustrating an example of statistical information stored in an analysis data storage unit of the present embodiment.

FIG. 7 is a diagram illustrating an example of correlation coefficients stored in the analysis data storage unit of the present embodiment.

FIG. 8 is a flowchart illustrating an operation example of a server device (cooperation management device) according to the present embodiment.

### DETAILED DESCRIPTION OF THE INVENTION

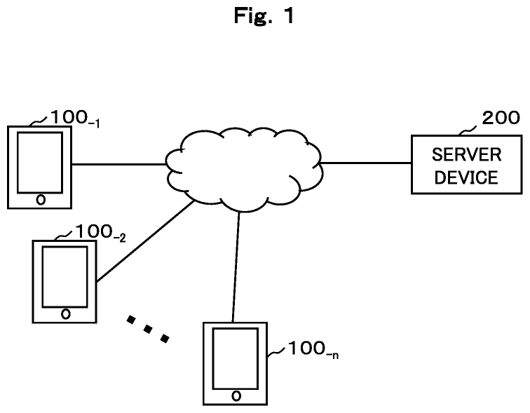

Hereinafter, an embodiment of the present invention will be described with reference to the drawings. FIG. 1 is a diagram illustrating an example of an overall configuration of a chat/task management system to which a cooperation management device according to the present embodiment is applied. As illustrated in FIG. 1, the chat/task management system includes a plurality of user terminals 100₋₁, 100-₋₂, . . . , 100₋ₙ (hereinafter, simply referred to as a user terminal 100) and a server device 200, and the user terminal 100 and the server device 200 are configured to be connectable via a communication network including the Internet or a mobile phone network.

The user terminal 100 includes, for example, a mobile terminal such as a smartphone, a tablet terminal, or a notebook personal computer, or a stationary personal computer. In the user terminal 100, a dedicated application program (hereinafter referred to as a dedicated application) is installed for using a chat management function and a task management function provided by the chat/task management system. A user who uses the user terminal 100 receives an issue of a user ID and a password by performing user registration with the server device 200 through the dedicated application. The user registration is performed, for example, by registering attribute information, for example, the user's name, department, and the like.

The server device 200 corresponds to the cooperation management device, and provides a task management function and a chat management function to the user terminal 100 where the user registration was performed. The task management function and the chat management function cooperate with each other, and the server device 200 manages the task performed by the user and the chat, which is a communication means between the users in the task, in cooperation with each other. Further, the server device 200 has an information processing function such as statistical processing and tendency analysis and a result information presentation function, and also operates these functions in cooperation with the task management function and the chat management function.

The task management function mainly generates the task, manages contents and the like assigned to the task, and manages a state transition from start to completion of the task. The chat management function mainly generates a chat room in association with the task, and manages a message exchange between users performed in the chat room and the assigned content and the like. Further, in the chat management function, when a task state becomes “completed, ” a chat room for reviewing the task is automatically generated. In the information processing function, when the task state is “completed,” a predetermined statistical processing, tendency analysis, and the like are performed using management information related to the task and management information related to the chat. In the information presentation function, the contents of information processing are presented to the user by posting a result of the information processing to the automatically generated chat room for review.

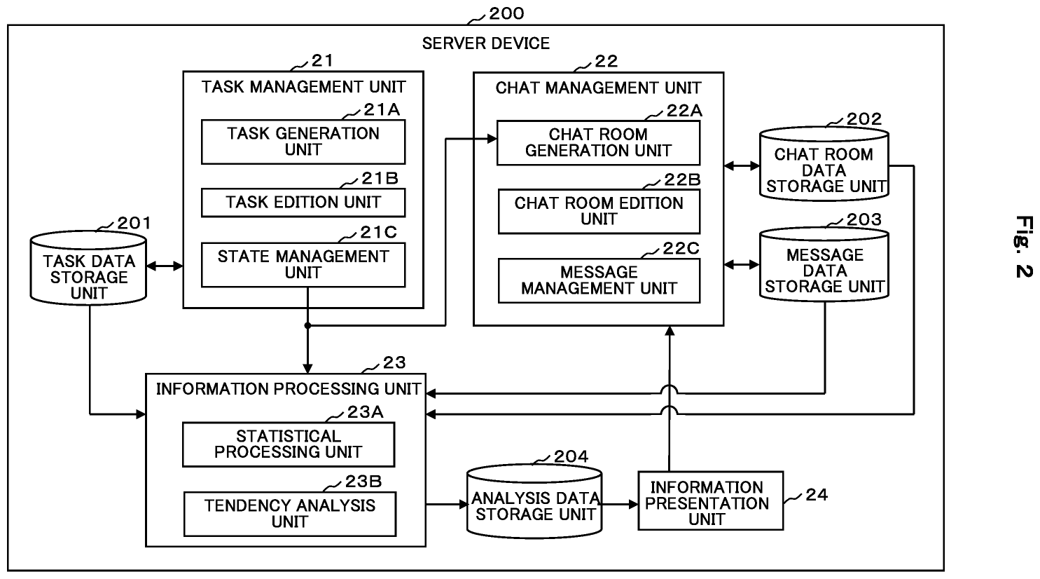

Details of each function described above will be described with reference to FIG. 2. FIG. 2 is a block diagram illustrating a functional configuration example of the server device 200 (cooperation management device) according to the present embodiment. As illustrated in FIG. 2, the server device 200 of the present embodiment includes a task data storage unit 201, a chat room data storage unit 202, a message data storage unit 203, and an analysis data storage unit 204 as storage media.

Further, the server device 200 of the present embodiment includes a task management unit 21, a chat management unit 22, an information processing unit 23, and an information presentation unit 24 as functional configurations. The task management unit 21 includes a task generation unit 21A, a task edition unit 21B, and a state management unit 21C as more specific functional configurations. The chat management unit 22 includes a chat room generation unit 22A, a chat room edition unit 22B, and a message management unit 22C as more specific functional configurations. The information processing unit 23 includes a statistical processing unit 23A and a tendency analysis unit 23B as more specific functional configurations.

The functional blocks 21 to 24 can be configured by any of hardware, a digital signal processor (DSP), and software. For example, when configured by software, each of the functional blocks 21 to 24 is actually configured by including a CPU, RAM, ROM, and the like of a computer, and is realized by operating a program stored in a recording medium such as RAM, ROM, hard disk, or semiconductor memory.

The task management unit 21 manages task generation, a person in charge of executing the task, contents assigned to the task, and the state transition from generation to start and completion of the task. The task handled in the present embodiment is a task that is performed jointly by a plurality of members, and is a task for which several days to several weeks are normally required, or several months are required depending on the contents. For example, a ToDo list such as “preparation of planning meeting materials for next week,” “contact the other party for a product price,” and “new product idea,” or a project which is big to some extent corresponds to the task of the present embodiment.

When starting the task as described above, one or more people in charge of executing the task are generally determined. Moreover, the contents used for executing the task are provided as needed. The contents described here are a data file necessary for executing the task, uniform resource locator (URL) information of the Internet site to be referred to, and the like. The data file includes various files such as a document file, an image file, and an audio file. In addition, after starting the execution of the task, information is exchanged among a plurality of members participating in the task, and related data files are exchanged. In the present embodiment, the chat is used as a communication means for exchanging information and exchanging data files.

The chat management unit 22 manages generation of the chat room that is a communication space for the chat in association with the task generated by the task management unit 21, participants in the chat room, message exchange in the chat room, and contents assigned to the chat. The chat room handled in the present embodiment corresponds to the task, and in many cases, one chat room corresponds to one task. Note that a plurality of chat rooms can be generated and associated with one task. Therefore, the task and the chat room have a relationship of 1:1 or 1:n (n is 2 or more). However, one chat room is associated with only one task. Therefore, the task and the chat room do not have a relationship of m:1 (m is 2 or more) or m:n.

The task generation unit 21A generates a task according to an instruction from the user. In addition, when the chat room is generated by the chat room generation unit 22A in response to an instruction from the user, the task generation unit 21A may automatically generate the task using the generation of the chat room as a trigger. The task described here is not a job processed by a computer, but an actual operation performed by a plurality of members. Therefore, the generation of the task means registering who is in charge of executing what task with the server device 200. Such a task is generated by issuing a task ID, setting a task title (a task name or a character string indicating the contents of the task), and registering the person in charge of executing the task.

In case that the task is generated in response to the instruction from the user, for example, the user activates the dedicated application on the user terminal 100 and accesses the server device 200 to display a predetermined task generation screen on the user terminal 100. Then, when the user inputs a task title or a person in charge of executing the task through the task generation screen and performs an operation to instruct generation of the task, the task generation unit 21A generates the task according to the instruction. Here, the person in charge of the execution can be input by, for example, displaying a list of names of a plurality of users registered as the users in the server device 200 and designating a pertinent user from the list.

The task generation unit 21A issues a task ID that is identification information that can uniquely identify the generated task. Then, the task generation unit 21A stores, in association with the task ID, a task title, a user ID of the user designated as the person in charge of executing the task (hereinafter, the user ID related to the person in charge of executing the task is particularly referred to as a person in charge ID), and Information indicating generation date and time of the task in the task data storage unit 201, as management information related to the task (hereinafter referred to as task management information).

In addition, when a data file is attached through the task generation screen, the task generation unit 21A stores the data file in association with the task ID, issues a file ID which is identification information that can uniquely identify the attached data file, and stores the same along with a file name in association with the task ID in the task data storage unit 201, as the task management information. In addition, when URL information of the Internet site is input through the task generation screen, the task generation unit 21A associates the URL information with the task ID and stores the URL information in the task data storage unit 201, as the task management information.

On the other hand, in case that the task is automatically generated with the generation of the chat room as a trigger, the task generation unit 21A automatically generates the task in association with the chat room generated by the chat room generation unit 22A. In this case, for example, the task generation unit 21A issues the task ID and sets a temporary name as the task title. Note that the room name assigned to the chat room may be designated as the task title as it is. Further, the task generation unit 21A may designate a part or all of the users designated as participants in the chat room as the person in charge of executing the task.

The contents of the task generated by the task generation unit 21A can be freely browsed and edited by the user at any timing until the task is completed, including attached files and URL information. The task edition unit 21B performs processing related to the browsing and edition of the task. For example, when the user activates the dedicated application on the user terminal 100 and accesses the server device 200, a predetermined task browsing screen is displayed on the user terminal 100. On the task browsing screen, the task management information stored in the task data storage unit 201 is displayed, and when the file name that is one of the task management information is clicked, it is also possible to open and browse an attached file. Further, it is also possible to browse related Internet sites by clicking on the URL.

In addition, when the user activates a dedicated application on the user terminal 100 and accesses the server device 200, a predetermined task edition screen is displayed on the user terminal 100. On the task edition screen, the task management information stored in the task data storage unit 201 is displayed, and when the file name which is one of the task management information is clicked, it is also possible to open and browse an attached file. Then, the user can edit any of the task title, the person in charge of execution, and the URL information, delete or add the attached file, or update the contents of the attached file, and in response to such a user operation, the task edition unit 21B updates the task management information or the attached file stored in the task data storage unit 201 in response to such a user operation.

The chat room generation unit 22A generates the chat room in response to the instruction from the user. Further, the chat room generation unit 22A may automatically generate the chat room using the task generation by the task generation unit 21A as a trigger. As described above, the task and the chat room correspond to each other with a relationship of 1:1 or 1:n, and the person in charge of executing certain task is also a participant in the chat room related to the task. Note that the person in charge of executing the task and the participant of the chat room are not necessarily the same, and members other than the person in charge of executing the task may be the participants in the chat room. For example, when the person in charge of executing the task becomes a center (for example, a responsible person) and other members are added to execute the task, the members other than the person in charge of executing the task (co-executor) are also the participants in the chat room.

In case that the chat room is generated in response to the instruction from the user, for example, the user activates a dedicated application on the user terminal 100 and accesses the server device 200 to display a predetermined chat room generation screen on the user terminal 100. Then, when the user performs an operation of inputting a chat room name (room name), a participant, and a related task ID through the chat room generation screen and instructing generation of the chat room, the chat room generation unit 22A generates the chat room according to the instruction. Here, the input of the chat room participant can be performed by, for example, displaying a list of names of a plurality of users registered as the users in the server device 200 and designating a pertinent user from the list.

The chat room generation unit 22A issues a room ID that is identification information that can uniquely identify the generated chat room. Then, the chat room generation unit 22A stores, in association with the room ID, a room name, a user ID of the user designated as the participant in the chat room (hereinafter, the user ID related to the participant in the chat room is particularly referred to as a participant ID), and the related task ID in the chat room data storage unit 202 as management information related to chat (hereinafter referred to as chat management information).

On the other hand, in case that the chat room is automatically generated using generation of the task as a trigger, the chat room generation unit 22A automatically generates the chat room in association with the task generated by the task generation unit 21A. In this case, for example, the chat room generation unit 22A issues the room ID and sets a temporary name as the room name. Note that the task title assigned to the task may be designated as the room name as it is. Further, the chat room generation unit 22A may designate all the users designated as the person in charge of executing the task as the participants in the chat room.

The contents of the chat room generated by the chat room generation unit 22A can be freely browsed or edited by the user at any timing until the task is completed. The chat room edition unit 22B performs processing related to browsing and edition of the chat room. For example, when the user activates the dedicated application on the user terminal 100 and accesses the server device 200, a predetermined chat room browsing screen is displayed on the user terminal 100. The chat management information stored in the chat room data storage unit 202 is displayed on the chat room browsing screen.

In addition, when the user activates the dedicated application on the user terminal 100 and accesses the server device 200, a predetermined chat room edition screen is displayed on the user terminal 100. On the chat room edition screen, the chat management information stored in the chat room data storage unit 202 is displayed. Then, the user can edit either the room name or the participant in the chat room, and the chat room edition unit 22B updates the chat management information stored in the chat room data storage unit 202 in response to such a user operation.

The message management unit 22C manages transmission and reception of messages to and from the chat room. The messages transmitted and received in the chat room are various including messages including simple text sentence, messages attached with various data files such as document files, image files, and audio files, messages where URL information as hyperlinks is written, and the like. The message management unit 22C executes the exchange of these various messages by applying a known chat technology, issues a message ID for the exchanged message, and stores, in association with the message ID, message contents data in the message data storage unit 203.

When the message contents data is stored in the message data storage unit 203, the message management unit 22C issues a message ID, which is identification information that can uniquely identify each message and stores, in association with the message ID, a user ID of a poster, posting date and time, and the room ID of the chat room in which the message is exchanged in the message data storage unit 203, as the chat management information. Further, when a data file is attached to the message, the message management unit 22C stores the data file in association with the message ID, issues a file ID of the attached data file, and stores the same along with the file name in association with the message ID in the message data storage unit 203, as the chat management information. Further, when URL information is included in the message, the message management unit 22C associates the URL information with the message ID and stores the URL information in the message data storage unit 203, as the chat management information.

The state management unit 21C manages the state transition from the start to the completion of the task after the task is generated by the task generation unit 21A. The start and completion of the task are designated by the user using the dedicated application, for example. That is, when starting the task, when the user designates the start from the dedicated application, the state management unit 21C stores information indicating the start date and time of the task in the task data storage unit 201, as the task management information. Further, when the task is completed, when the user designates the completion from the dedicated application, the state management unit 21C stores information indicating the completion date and time of the task in the task data storage unit 201, as the task management information.

Note that when a predetermined state is detected, the state management unit 21C may regard that as the start of the task, and store the date and time at that time in the task data storage unit 201 as the start date and time of the task. For example, a text sentence of the message posted in the chat room may be analyzed, and when it is detected that the contents meaning the start of the task are described, it may be regarded as the start of the task.

Similarly, when a predetermined state is detected, the state management unit 21C may regard that as completion of the task, and may store the date and time at that time in the task data storage unit 201, as task completion date and time. For example, the text sentence of the message posted in the chat room may be analyzed, and when it is detected that the contents meaning the completion of the task are described, it may be regarded as the completion of the task.

The method for designating the start and the completion of the task described above is merely an example, and the present invention is not limited thereto. That is, a predetermined state to be regarded as the start and the completion of the task is defined in advance and registered in the state management unit 21C, and when the defined state is detected, it may be regarded as the start and the completion of the task. The predetermined state can be arbitrarily defined.

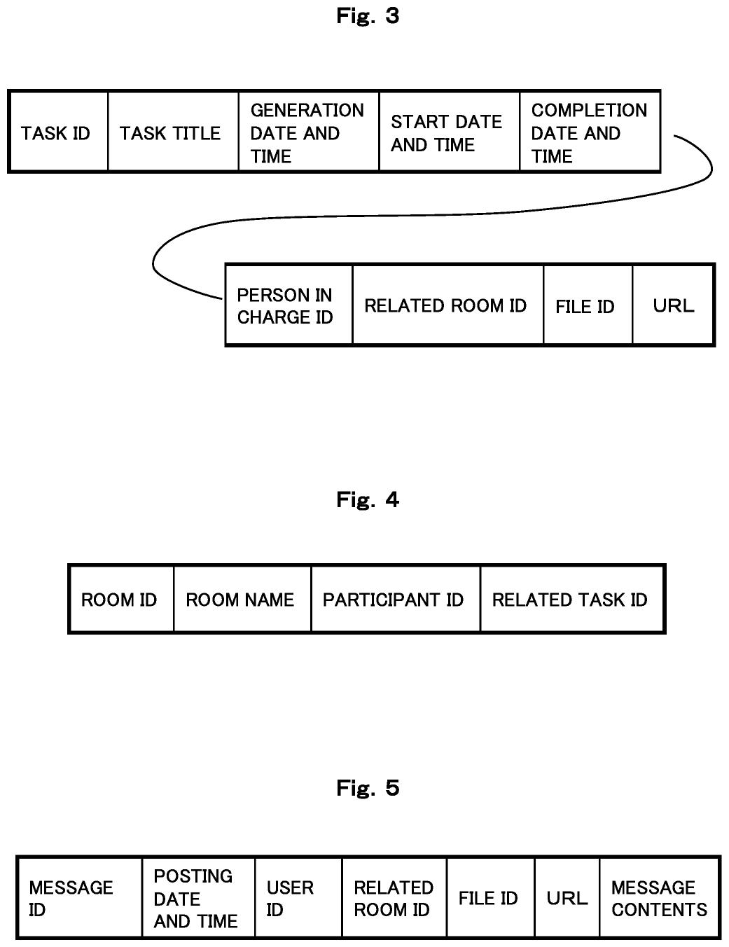

FIG. 3 is a diagram illustrating an example of the task data (task management information) stored in the task data storage unit 201. As illustrated in FIG. 3, the task data includes a task ID, a task title, task generation date and time, start date and time, completion date and time, a person in charge ID (for one or more people), and a room ID of the chat room related to the task (one or more), a file ID (one or more) of the data file assigned to the task, and URL information (one or more) assigned to the task. Note that the task data may include other information.

As described above, by storing the generation date and time, the start date and time, and the completion date and time of the task in the task data storage unit 201, the state management unit 21C can manage three states including “before start” of the task (a period from the generation date and time to the start date and time), “during execution” of the task (a period from the start date and time to the completion date and time), and “completion” of the task (after the completion date and time) as a state to which the task can transition.

FIG. 4 is a diagram illustrating an example of chat room data (chat management information) stored in the chat room data storage unit 202. As illustrated in FIG. 4, the chat room data includes a room ID, a room name, participant IDs of all participants, and a task ID of the task related to the chat room. Note that the chat room data may include other information.

FIG. 5 is a diagram illustrating an example of message data (chat management information) stored in the message data storage unit 203. As illustrated in FIG. 5, the message data includes a message ID, posting date and time, a user ID of the poster, a room ID of the chat room where the message is posted, a file ID (one or more) of the data file attached to the message, URL information (one or more) included in the message, and message contents. Note that the message data may include other information.

When the task generated by the task management unit 21 is completed (that is, when the completion date and time of the task is stored in the task data storage unit 201 by the state management unit 21C), the information processing unit 23 performs predetermined information processing by using one or more pieces of the task management information which is managed in the task data storage unit 201 by the task management unit 21 and one or more pieces of the chat management information managed in the chat room data storage unit 202 and the message data storage unit 203 by the chat management unit 22. The information processing is executed by the statistical processing unit 23A and the tendency analysis unit 23B.

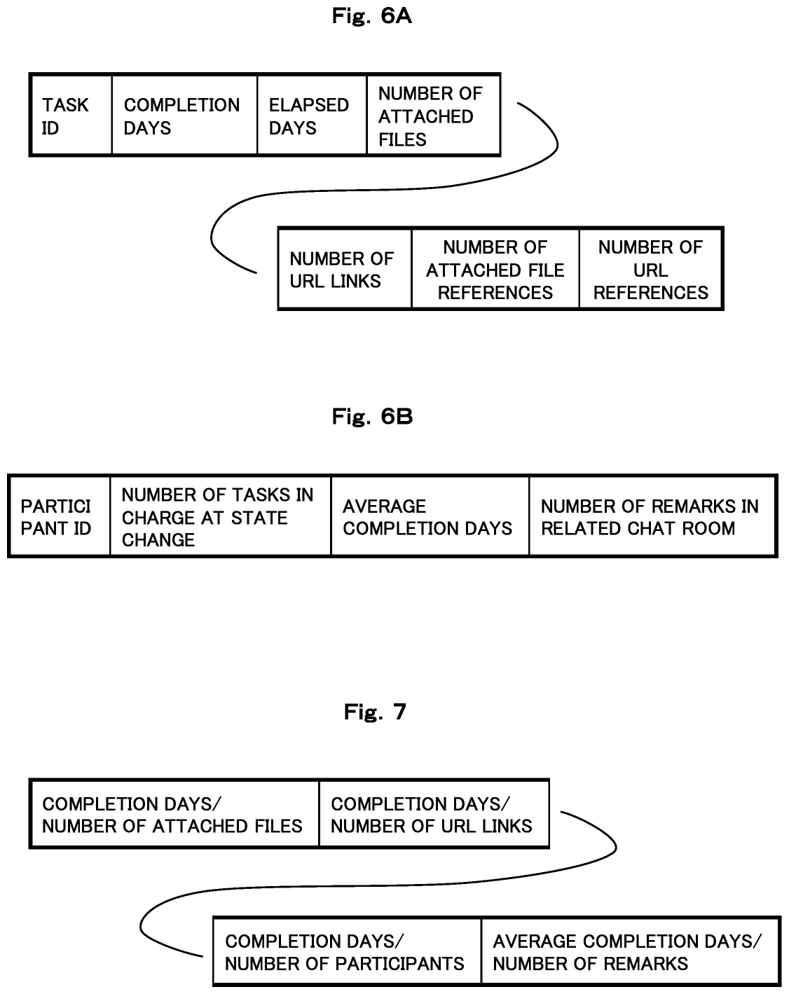

The statistical processing unit 23A performs predetermined statistical processing by using one or more pieces of the task management information related to the task and one or more pieces of the chat management information related to the chat performed in the chat room relating to the task. The statistical processing unit 23A stores statistical information calculated by using one or more pieces of the task management information and one or more pieces of the chat management information in the analysis data storage unit 204. FIGS. 6A and 6B are diagrams illustrating an example of statistical information stored in the analysis data storage unit 204. The statistical processing unit 23A calculates statistical information related to the task illustrated in FIG. 6A and statistical information related to the user (the participant in the chat room related to the task) illustrated in FIG. 6B.

As illustrated in FIG. 6A, the statistical processing unit 23A calculates completion days of the task, elapsed days of the task, the number of attached files, the number of URL links, the number of attached file references, and the number of URL references, and stores information thereof, in association with the task ID, in the analysis data storage unit 204, as statistical information related to the task. The completion days of the task are the number of days required from the start to the completion of the task, and are calculated by subtracting the start date and time of the task from the completion date and time of the task illustrated in FIG. 3. The elapsed days of the task are the elapsed days from the generation of the task to the present time, and are calculated by subtracting the generation date and time of the task illustrated in FIG. 3 from the present date and time.

The number of attached files is the total number of data files attached to the task and data files attached to the messages exchanged in the chat room, and is calculated by summing up the number of file IDs illustrated in FIG. 3 and the number of file IDs illustrated in FIG. 5. The number of URL links is the total number of the URL information assigned to the task and the URL information described in the message exchanged in the chat room, and is calculated by summing up the number of the URL information illustrated in FIG. 3 and the number of the URL information illustrated in FIG. 5.

The number of attached file references is a total value of the number of times the data file attached to the task and the data file attached to the message are referenced, and is a numerical value that is incremented each time it is detected that the data file has been opened. The number of URL references is a total value of the number of times the URL information attached to the task and the URL information attached to the message are clicked, and is a numerical value that is incremented each time it is detected that the click is performed.

Further, as illustrated in FIG. 6B, the statistical processing unit 23A calculates, as statistical information related to the user, the number of tasks in charge at the time of each state change, an average completion days of the tasks, and the number of remarks in the related chat room, and stores information thereof, in association with the participant ID, in the analysis data storage unit 204. The number of tasks in charge at the time of each state change is a value indicating the number of tasks which the user indicated by the participant ID of FIG. 6B is in charge of in each of a case where the completed task (hereinafter referred to as the present task) was changed from “before start” to “during execution” and a case where the task was changed from “during execution” to “completed.” The number of tasks in charge is a number obtained by summing up the tasks for which the user is registered as the person in charge ID in FIG. 3 (including both the tasks that have already been completed and the tasks that are currently being executed) and which the user was actually in charge at the time of the state change of the present task.

The number of the average completion days of tasks is an average value of the completion days of tasks of which the user indicated by the participant ID in FIG. 6B is in charge. In case that a user is in charge of a plurality of tasks, the average completion days are calculated by averaging the days related to the tasks of which the user is in charge among completion days stored for each task ID in FIG. 6A. The number of remarks in the related chat room is a value indicating the total number of messages posted by the user indicated by the participant ID in FIG. 6B in one or more chat rooms related to the completed task. The number of remarks may be calculated for each posting date or each task state.

The tendency analysis unit 23B uses any combination of one or more pieces of the task management information related to the task, one or more pieces of the chat management information related to the chat, and the statistical information calculated by the statistical processing unit 23A, and analyzes a tendency of a relationship between pieces of information related to the combination. The task management information and the chat management information used by the tendency analysis unit 23B for tendency analysis may relate to one task for which the completion has been detected and one or more chat rooms related thereto, and in addition to this, may relate to the tasks already completed and the chat rooms related to the tasks respectively.

For example, when the task generated by the task management unit 21 is completed (that is, when the completion date and time of the task is stored in the task data storage unit 201 by the state management unit 21C), the tendency analysis unit 23B uses any combination of the task management information relating to the completed task, the chat management information relating to one or more chat rooms relating to the completed task, and the statistical information calculated by the statistical processing unit 23A regarding the completed task, and analyzes a tendency of a relationship between the information relating to the combination. In this case, it is possible to analyze the tendency (specific tendency seen with respect to the completed task) that is significantly observed in a series of processes from generation to completion of the completed task.

In addition, when the task generated by the task management unit 21 is completed, the tendency analysis unit 23B uses any combination of the task management information related to the completed task and the tasks completed in the past, the chat management information relating to a plurality of chat rooms related to those tasks, and the statistical information calculated by the statistical processing unit 23A regarding those tasks, and analyzes a tendency of a relationship between the information relating to the combination. In this case, it is possible to analyze the tendency that is significantly observed for the entire tasks completed so far.

In case that analyzing the tendency of the entire task as in the latter case, the tendency analysis unit 23B uses, for example, any combination of the statistical information calculated by the statistical processing unit 23A, analyzes a correlation between the information relating to the combination, and detects a combination of pieces of information having a significant correlation with a correlation coefficient larger than a predetermined value. The calculation of the correlation coefficient can be performed using a known method. That is, the tendency analysis unit 23B calculates a correlation coefficient for one or more combinations using any of a plurality of pieces of statistical information illustrated in FIGS. 6A and 6B and stores the calculated correlation coefficient in the analysis data storage unit 204. Then, a combination of pieces of information corresponding to the correlation coefficient larger than a predetermined value is detected among the calculated one or more correlation coefficients.

FIG. 7 is a diagram illustrating an example of correlation coefficients stored in the analysis data storage unit 204. As illustrated in FIG. 7, the tendency analysis unit 23B calculates the correlation coefficient between the completion days of the tasks and the number of attached files, the correlation coefficient between the completion days of the tasks and the number of URL links, the correlation coefficient between the completion days of the tasks and the number of participants in the related chat room, and the correlation coefficient between the average completion days of the tasks and the number of remarks in the related chat room, and stores these correlation coefficients in the analysis data storage unit 204. Then, a combination of pieces of information corresponding to the correlation coefficient larger than a predetermined value is detected among these correlation coefficients.

The information presentation unit 24 presents the result of the information processing by the information processing unit 23 to the user when the task generated by the task management unit 21 is completed. That is, the information presentation unit 24 presents the statistical information calculated by the statistical processing unit 23A to the user. Moreover, the information presentation unit 24 generates tendency information which shows the contents of the tendency detected by the tendency analysis unit 23B, and presents the tendency information to the user. When the combination of pieces of information having the significant correlation is detected by the tendency analysis unit 23B, the information presentation unit 24 generates correlation information indicating the contents of the correlation as tendency information, and presents the correlation information to the user. The tendency information may be information that expresses the contents of the tendency in the form of a sentence, may be information that is expressed in the form of a graph, or may be information that is expressed in the form of a relationship diagram based on a line drawing.

For example, in case that the contents of the tendency are expressed in the form of a sentence, the information presentation unit 24 presents to the user a sentence “As the number of the participants increases, the completion days tend to be shorter” and the like, as the contents indicating “correlation between the completion days of the task and the number of participants in the related chat room” illustrated in FIG. 7. As another example, the information presentation unit 24 presents to the user a sentence “a person in charge of the task who makes a large number of remarks tends to have short completion days” and the like as the contents indicating “correlation between the average completion days of the tasks and the number of remarks in the related chat room” illustrated in FIG. 7.

Alternatively, the information presentation unit 24 presents to the user sentences such as “the number of related URL links increases before the start of the task” and “the number of times the attached file “000” is referenced increases before the completion of the task,” as contents indicating the result of the tendency analysis for each state of the task performed by the tendency analysis unit 23B using the task management information and the statistical information. Further, the information presentation unit 24 presents to the user a sentence “the total number of remarks increases after the remark of Mr. OO” and the like, as the contents indicating the result of the tendency analysis unit 23B analyzing a relationship between the number of remarks of a specific user calculated by the statistical processing unit 23A and the number of remarks of all participants.

Further, in case that the contents of the tendency are expressed in the form of a graph, the information presentation unit 24 can form, for example, a graph area of 2D coordinates in which one of the information used when the tendency analysis unit 23B analyzes the relationship is set on the horizontal axis, and the other information is set on the vertical axis, and generate a scatter diagram graph in which a predetermined mark is plotted at a position of a coordinate value determined by a combination of each information value. Further, a correlation function may be calculated from a plurality of plot points, and a line graph representing the calculated correlation function using a straight line or a curved line may be generated. Further, the format of the graph is not limited to the two-dimensional coordinate system graph as described above, and may be a pie graph or a donut graph. Further, when the tendency analysis unit 23B analyzes the relationship among three or more pieces of information, the information presentation unit 24 may present the contents of the analysis result in a format such as a pie graph, a donut graph, a bubble chart, or a radar chart.

Information presentation by the information processing unit 23 may be performed by, for example, generating a dedicated information presentation screen and displaying the same on the user terminal 100. As another example, when the task generated by the task management unit 21 is completed, the chat management unit 22 generates a new chat room (a chat room for review), and the information presentation unit 24 may post the result of the information processing by the information processing unit 23 as a first message to the new chat room. When the chat room for review is generated and the result of the information processing by the information processing unit 23 is posted, the participants can easily discuss with each other while referring to the information posting in the chat room for review.

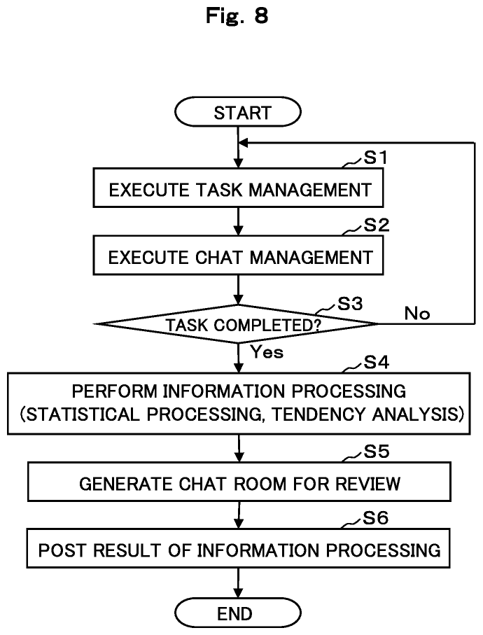

FIG. 8 is a flowchart illustrating an operation example of the server device 200 (cooperation management device) configured as described above. In FIG. 8, the task management unit 21 manages task generation, a person in charge of executing the task, contents assigned to the task, and state transition from generation to start and completion of the task (step S1). In other words, the task management unit 21 monitors whether or not an event for generating or updating the task data illustrated in FIG. 3 has occurred, executes processing related to the generated event, and updates the related task management information (task data).

The chat management unit 22 manages generation of the chat room that is a communication space for performing the chat in association with the task generated by the task management unit 21, the participant in the chat room, message exchange in the chat room, and the contents assigned to the chat (step S2). That is, the chat management unit 22 monitors whether or not an event for generating or updating the chat room data illustrated in FIG. 4 and the message data illustrated in FIG. 5 has occurred, executes processing related to the generated event and updates the related chat management information (chat room data and message data).

The information processing unit 23 determines whether or not any task has been completed by monitoring whether or not the completion date and time of the task is stored in the task data storage unit 201 by the state management unit 21C (step S3). If no task is completed, the process returns to step S1. On the other hand, when any task is completed, the information processing unit 23 performs predetermined information processing by using one or more pieces of the task management information stored in the task data storage unit 201 and one or more pieces of the chat management information stored in the chat room data storage unit 202 and the message data storage unit 203 (step S4).

Next, the chat management unit 22 generates a chat room for review (step S5). Then, the information presentation unit 24 posts the result processed by the information processing unit 23 in step S4 (statistical information calculated by the statistical processing unit 23A, tendency information analyzed by the tendency analysis unit 23B) as the first message to the chat room for review, thereby presenting the result of the information processing to the user (step S6). Thus, the process of the flowchart illustrated in FIG. 8 ends.

As described above in detail, in the present embodiment, the generation of the task performed by the user, the person in charge of executing the task, the contents assigned to the task, and the state transition from the start to the completion of the task are managed, and the generation of the chat room for performing the chat in association with the task, the participants in the chat room, the exchange of messages in the chat room, and the contents assigned to the chat are also managed. Then, when the task is completed, the predetermined information processing is performed using the task management information and the chat management information, and the result of the information processing is presented to the user.

According to the embodiments configured as described above, when execution of the task is completed in cooperation with chat, one or more pieces of the task management information related to the task managed during execution of the task and one or more pieces of the chat management information related to the chat are used to perform the predetermined information processing, and the result of the information processing is presented to the user. The result of this information processing shows the execution state of the task and the chat, and is useful information as information to be referred to during review or self-reflection. By referring to the presented information, the user can effectively improve the next task execution based on the situation during execution of the task.

Note that in the above-described embodiments, the examples in which the information processing unit 23 includes the statistical processing unit 23A and the tendency analysis unit 23B have been described, but the information processing unit 23 may include only one of them.

Further, in the above embodiments, the examples in which the result of the information processing is provided when the task is completed have been described, but the present invention is not limited thereto. The information may be processed at an arbitrary timing according to a request through a user operation, and the result may be presented to the user. In this way, it is possible to provide the user with useful information that contributes to improvement regarding the task currently being executed.

In addition, each of the above-described embodiments is merely an example of implementation in carrying out the present invention, and a technical scope of the present invention should not be construed in a limited manner according to the example. That is, the present invention can be implemented in various forms without departing from the gist or the main features thereof.

1. A cooperation management device for managing a task performed by users and a chat that is a communication means between the users in the task in cooperation with each other, the device comprising:
a task management unit that manages generation of the task, a person in charge of executing the task, contents assigned to the task, and a state transition from the generation of the task to a start and a completion of the task;
a chat management unit that manages generation of a chat room that is a communication space for performing the chat in association with the task, participants in the chat room, message exchange in the chat room, and contents assigned to the chat;
an information processing unit that performs a predetermined information processing by using one or more pieces of task management information relating to the task managed by the task management unit and one or more pieces of chat management information relating to the chat managed by the chat management unit; and
an information presentation unit that presents a result of the information processing by the information processing unit to the user.

2. The cooperation management device according to claim 1, wherein the information processing unit includes a statistical processing unit that performs a predetermined statistical processing by using the one or more pieces of task management information and the one or more pieces of chat management information, and
wherein the information presentation unit presents statistical information calculated by the statistical processing unit to a user.

3. The cooperation management device according to claim 2, wherein the information processing unit further includes a tendency analysis unit that uses any combination of the one or more pieces of task management information, the one or more pieces of chat management information, and the statistical information calculated by the statistical processing unit and analyzes a tendency of a relationship between pieces of information related to the combination, and
wherein the information presentation unit generates tendency information which indicates contents of the tendency detected by the tendency analysis unit and presents to the user the tendency information in place of or in addition to the statistical information.

4. The cooperation management device according to claim 3, wherein the tendency analysis unit uses any combination of the statistical information calculated by the statistical processing unit, analyzes a correlation between pieces of information relating to the combination, and detects a combination of pieces of information having a significant correlation with a correlation coefficient larger than a predetermined value, and
wherein the information presentation unit generates correlation information indicating contents of the correlation as the tendency information based on the combination of pieces of information having the significant correlation detected by the tendency analysis unit, and presents to the user the correlation information in place of or in addition to the statistical information.

5. The cooperation management device according to claim 1, wherein when the task generated by the task management unit is completed, the chat management unit generates a new chat room, and the information presentation unit posts the result of the information processing by the information processing unit as a first message to a new chat room.

6. A cooperation management method for managing a task performed by users and a chat performed between the users in association with the task, in cooperation with each other, in a cooperation management device including: a task management function of managing generation of the task, a person in charge of executing the task, contents assigned to the task, and a state transition from the generation of the task to a start and a completion of the task; and a chat management function of managing generation of a chat room that is a communication space for performing the chat, participants in the chat room, message exchange in the chat room, and contents assigned to the chat, the method comprising:
performing, by an information processing unit of the cooperation management device, a predetermined information processing by using one or more pieces of task management information relating to the task and one or more pieces of chat management information relating to the chat when the task is completed; and
presenting, by an information presentation unit of the cooperation management device, a result of the information processing by the information processing unit to the user.

7. The cooperation management device according to claim 2, wherein when the task generated by the task management unit is completed, the chat management unit generates a new chat room, and the information presentation unit posts the result of the information processing by the information processing unit as a first message to a new chat room.

8. The cooperation management device according to claim 3, wherein when the task generated by the task management unit is completed, the chat management unit generates a new chat room, and the information presentation unit posts the result of the information processing by the information processing unit as a first message to a new chat room.

9. The cooperation management device according to claim 4, wherein when the task generated by the task management unit is completed, the chat management unit generates a new chat room, and the information presentation unit posts the result of the information processing by the information processing unit as a first message to a new chat room.
